(19) United States
(12) Patent Application Publication
(10) Pub. No.: US 2021/0304225 A1
(43) Pub. Date: Sep. 30, 2021

(54) INFORMATION PROCESSING METHOD

(71) Applicant: KDDI CORPORATION, Tokyo (JP)

(72) Inventors: Kei ISHIGOUOKA, Tokyo (JP); Daisaku KASHIMA, Tokyo (JP); Kazuki YAGUMA, Tokyo (JP); Kyohei TSUJI, Tokyo (JP)

(73) Assignee: KDDI CORPORATION, Tokyo (JP)

(21) Appl. No.: 17/172,430

(22) Filed: Feb. 10, 2021

(30) Foreign Application Priority Data
Mar. 31, 2020 (JP) 2020-061988
Mar. 31, 2020 (JP) 2020-061989

(51) Int. Cl. G06Q 30/02; G06Q 20/20; G06Q 20/32; G06F 16/245

(52) U.S. Cl. CPC G06Q 30/0201; G06Q 20/204; G06Q 20/3274; G06K 19/06028; G06F 16/245; G06Q 20/208; G06Q 30/0255; G06Q 30/0259

(57) ABSTRACT

A payment processing device includes a token transmission unit that stores a user ID in a storage unit in association with a payment token for generating a payment code when a request for issuing the payment code is acquired from a user terminal and transmits the payment token to the user terminal, a payment information receiving unit that receives the payment token, store information, payment information about a purchase of a product or service by a user at a store from a store terminal that has read the payment code displayed by the user terminal on the basis of the payment token, and an advertisement information transmission unit that acquires presentation information including information about a store different from the store, information about a business operator different from the business operator of the store, or information about a predetermined product on the basis of the received store information in a case where the payment token stored in the storage unit matches the received payment token and transmits the acquired presentation information to the user terminal.

### BACKGROUND OF THE INVENTION

### Field of the Invention

The present invention relates to an information processing method of executing processing related to a code payment.

The present application claims priority based on Japanese Patent Application No. 2020-61988 and Japanese Patent Application No. 2020-61989 filed in Japan on Mar. 31, 2020, the contents of which are incorporated herein by reference.

### Description of Related Art

A code payment using a two-dimensional barcode such as a QR code (registered trademark) has become widespread (for example, Japanese Patent No. 6528160, Japanese Patent No. 6473539, and Japanese Patent No. 6542455). The two-dimensional barcode displayed by a store is read by a user terminal or the two-dimensional barcode displayed by the user terminal is read by the store to perform the code payment.

In the code payment in the related art, a coupon can be presented to all users who make the code payment to give a benefit corresponding to the coupon at the time of payment. However, there is a problem that various kinds of information, such as an advertisement effective for the user or information that the store wants to deliver, cannot be presented to the user according to a purchase status of the user.

### SUMMARY OF THE INVENTION

The present invention has been made in view of these points, and an object of the present invention is to provide an information processing method capable of presenting information to a user according to a purchase status of the user.

An information processing method according to a first aspect of the present invention includes acquiring a user identifier for specifying a user and a request for issuing a payment code for the user to make a payment at a store from a terminal of the user, storing the acquired user identifier and a payment token for generating the payment code in a storage unit in association with each other, transmitting the payment token to the terminal, receiving the payment token, store information for identifying the store, and payment information about a purchase of a product or service by the user at the store from a store terminal that has read the payment code displayed by the terminal on a basis of the payment token, making the payment on a basis of the user identifier associated with the payment token and the received payment information in a case where the payment token stored in the storage unit matches the received payment token, acquiring presentation information including information about a store different from the store, information about a business operator different from a business operator operating the store, or information about a predetermined product or service on a basis of the received store information in a case where the payment token stored in the storage unit matches the received payment token, and transmitting the acquired presentation information to the terminal, which are executed by a computer.

An information processing method according to a second aspect of the present invention includes acquiring a user identifier for specifying a user and a request for issuing a payment code for the user to make a payment at a store from a terminal of the user, storing the acquired user identifier and a payment token for generating the payment code in a storage unit in association with each other, transmitting the payment token to the terminal, receiving the payment token and payment information about a purchase of a product or service by the user at the store from a store terminal that has read the payment code displayed by the terminal on a basis of the payment token, making the payment on a basis of the user identifier associated with the payment token and the received payment information in a case where the payment token stored in the storage unit matches the received payment token, acquiring presentation information including information about a predetermined store, information about a predetermined business operator, or information about a predetermined product or service on a basis of the received payment information in a case where the payment token stored in the storage unit matches the received payment token, and transmitting the acquired presentation information to the terminal, which are executed by a computer.

An information processing method according to a third aspect of the present invention includes acquiring a user identifier for specifying a user and a request for issuing a payment code for the user to make a payment at a store from a terminal of the user, storing the acquired user identifier and a payment token for generating the payment code in a storage unit in association with each other, transmitting the payment token to the terminal, receiving the payment token, store information for identifying the store, and payment information about a purchase of a product or service by the user at the store from a store terminal that has read the payment code displayed by the terminal on a basis of the payment token, making the payment on a basis of the user identifier associated with the payment token and the received payment information in a case where the payment token stored in the storage unit matches the received payment token, acquiring presentation information including information about a predetermined store, information about a predetermined business operator, or information about a predetermined product or service on a basis of the user identifier associated with the payment token in a case where the payment token stored in the storage unit matches the received payment token, and transmitting the acquired presentation information to the terminal, which are executed by a computer.

An information processing method according to a fourth aspect of the present invention includes acquiring store information for identifying a store corresponding to a store terminal, payment information including an amount corresponding to a payment made by a user at the store, and a request for issuing a payment code for making the payment from the store terminal, storing the acquired store information and payment information and a payment token for generating the payment code in a storage unit in association with each other, transmitting the payment token to the store terminal, receiving the payment token and a user identifier for specifying the user from a terminal of the user that has read the payment code displayed by the store terminal on a basis of the payment token, making the payment on a basis of the store information and the payment information stored in the storage unit in association with the payment token in a case where the payment token stored in the storage unit matches the received payment token, acquiring presentation information to be presented to the user including information about a store different from the store, information about a business operator different from a business operator operating the store, or information about a predetermined product or service on a basis of the store information stored in the storage unit in association with the payment token, and transmitting the acquired presentation information to the terminal, which are executed by a computer.

An information processing method according to a fifth aspect of the present invention includes acquiring store information for identifying a store corresponding to a store terminal and a request for issuing a payment code for a user to make a payment at the store from the store terminal, storing the acquired store information and a payment token for generating the payment code in a storage unit in association with each other, transmitting the payment token to the store terminal, receiving the payment token, payment information including an amount corresponding to the payment, and a user identifier for specifying the user from a terminal of the user that has read the payment code displayed by the store terminal on a basis of the payment token, making the payment on a basis of the store information stored in the storage unit in association with the payment token and the received payment information in a case where the payment token stored in the storage unit matches the received payment token, acquiring presentation information to be presented to the user including information about a store different from the store, information about a business operator different from a business operator operating the store, or information about a predetermined product or service on a basis of the store information stored in the storage unit in association with the payment token, and transmitting the acquired presentation information to the terminal, which are executed by a computer.

An information processing method according to a sixth aspect of the present invention includes acquiring store information for identifying a store corresponding to a store terminal and a request for issuing a payment code for a user to make a payment at the store from the store terminal, storing the acquired store information and a payment token for generating the payment code in a storage unit in association with each other, transmitting the payment token to the store terminal, receiving the payment token, payment information including an amount corresponding to the payment, and a user identifier for specifying the user from a terminal of the user that has read the payment code displayed by the store terminal on a basis of the payment token, making the payment on a basis of the store information stored in the storage unit in association with the payment token and the received payment information in a case where the payment token stored in the storage unit matches the received payment token, acquiring presentation information to be presented to the user including information about a predetermined store, information about a predetermined business operator, or information about a predetermined product or service on a basis of the received payment information, and transmitting the acquired presentation information to the terminal, which are executed by a computer.

An information processing method according to a seventh aspect of the present invention includes acquiring store information for identifying a store corresponding to a store terminal and a request for issuing a payment code for a user to make a payment at the store from the store terminal, storing the acquired store information and a payment token for generating the payment code in a storage unit in association with each other, transmitting the payment token to the store terminal, receiving the payment token, payment information including an amount corresponding to the payment, and a user identifier for specifying the user from a terminal of the user that has read the payment code displayed by the store terminal on a basis of the payment token, making the payment on a basis of the store information stored in the storage unit in association with the payment token and the received payment information in a case where the payment token stored in the storage unit matches the received payment token, acquiring presentation information to be presented to the user including information about a predetermined store, information about a predetermined business operator, or information about a predetermined product or service on a basis of the received user identifier, and transmitting the acquired presentation information to the terminal, which are executed by a computer.

According to the present invention, there is an effect that information can be presented to the user according to the purchase status of the user.

### BRIEF DESCRIPTION OF THE DRAWINGS

FIG. 1 is a block diagram showing processing of a payment system according to a first embodiment.

FIG. 2 is a block diagram showing a functional configuration of a payment processing device according to the first embodiment and a second embodiment.

FIG. 3 is a table showing an example of an advertisement DB according to the first and second embodiments.

FIG. 4 is a table showing an example of a payment history DB according to the first and second embodiments.

FIG. 5 is a block diagram showing a functional configuration of a user terminal according to the first embodiment.

FIG. 6 is a block diagram showing a functional configuration of a store terminal according to the first embodiment.

FIG. 7 is a sequence diagram showing an operation of the payment system according to the first embodiment.

FIG. 8 is a block diagram showing processing of a payment system according to the second embodiment.

FIG. 9 is a block diagram showing a functional configuration of a user terminal according to the second embodiment.

FIG. 10 is a block diagram showing a functional configuration of a store terminal according to the second embodiment.

FIG. 11 is a sequence diagram showing an operation of the payment system according to the second embodiment.

FIG. 12 is a sequence diagram showing an operation of a payment system according to a modification example of the second embodiment.

### DETAILED DESCRIPTION OF THE INVENTION

### First Embodiment

### [Outline of Payment System 1S]

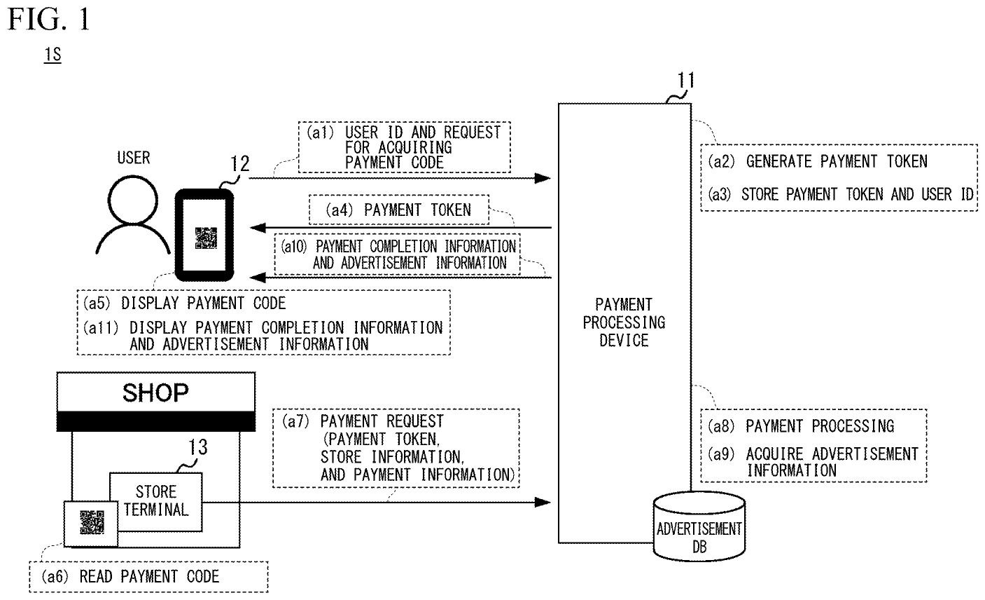

FIG. 1 is a diagram showing an outline of a payment system 1S. The payment system 1S displays a payment code on a user terminal in response to a request from the user terminal possessed by a user and makes a payment according to reading of the payment code on a store in a case where the user purchases a product at the store. The payment code is a text or an image that can be read by a terminal on the store used for settlement at the store and is a code used at the time of the payment.

The payment system 1S includes a payment processing device 11, a user terminal 12, and a store terminal 13. The payment processing device 11 is a server that makes the payment of a purchase amount. The payment processing device 11 also functions as an information processing device that presents advertisement information as presentation information to the user at the time of the payment of the purchase amount. The user terminal 12 is an information terminal used by the user and is, for example, a smartphone, a tablet, or a personal computer. The store terminal 13 is, for example, a POS terminal.

Hereinafter, a flow until the advertisement information is presented to the user will be described with reference to FIG. 1.

The user moves to the store and purchases the product at the store. In a case where the user performs accounting at the store, the user activates an application software for the payment and performs an operation for displaying the payment code on the user terminal 12. When the operation for displaying the payment code is received, the user terminal 12 transmits a user ID as a user identifier and a request for acquiring the payment code to the payment processing device 11 ((a1) in FIG. 1).

When the user ID and the request for acquiring the payment code are received from the user terminal 12, the payment processing device 11 generates a payment token ((a2) in FIG. 1). The payment token is a data string used when the user terminal 12 generates the payment code presented by the user at the store. The payment processing device 11 stores the generated payment token and the user ID in a storage medium in association with each other ((a3) in FIG. 1).

The payment processing device 11 transmits the generated payment token to the user terminal 12 ((a4) in FIG. 1). The payment processing device 11 may encrypt the payment token and then transmit the encrypted payment token to the user terminal 12.

The user terminal 12 generates and displays the payment code on the basis of the received payment token ((a5) in FIG. 1).

The user presents the payment code when a purchase price of the product is settled at a cash register of the store. The store terminal 13 reads the payment code displayed on the user terminal 12, for example, by an operation of a clerk ((a6) in FIG. 1).

The store terminal 13 transmits a payment request including payment information including a total amount of products to be purchased by the user, the payment token indicated by the read payment code, and store information for identifying the store to the payment processing device 11 ((a7) in FIG. 1).

When the payment token is received from the store terminal 13, the payment processing device 11 determines whether or not the received payment token matches the payment token transmitted to the user terminal 12. In a case where determination is made that the payment tokens match, the payment processing device 11 executes payment processing on the basis of the payment request ((a8) in FIG. 1).

In a case where the determination is made that the payment tokens match, the payment processing device 11 refers to an advertisement database (DB) in which the store information, a product ID that identifies the product included in the payment information, or the user ID is associated with each of a plurality of pieces of advertisement information to acquire the advertisement information presented to the user ((a9) in FIG. 1).

The payment processing device 11 transmits payment completion information indicating that the payment has been completed and the acquired advertisement information to the user terminal 12 ((a10) in FIG. 1). The user terminal 12 displays the received payment completion information and the advertisement information ((a11) in FIG. 1).

With the operation as described above, the payment system 18 can present the advertisement information effective for the user on the basis of a purchase status of the user, a store visit status, or the user 1D.

Details of configurations of the payment processing device 11, the user terminal 12, and the store terminal 13 will be described below.

### [Functional Configuration of Payment Processing Device 11]

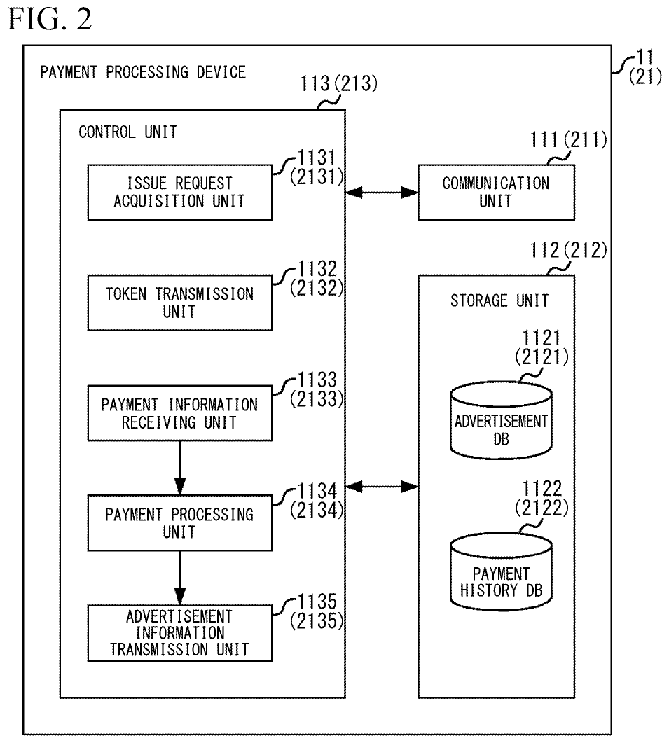

FIG. 2 is a diagram showing a functional configuration of the payment processing device 11. The payment processing device 11 has a communication unit 111, a storage unit 112, and a control unit 113.

The communication unit 111 is a communication interface for transmitting and receiving data to and from the user terminal 12 and the store terminal 13 through a network such as the Internet.

The storage unit 112 is a storage medium for storing various types of data and has a read only memory (ROM), a random access memory (RAM), a hard disk, and the like. The storage unit 112 stores a program executed by the control unit 113. The storage unit 112 stores a payment program that causes the control unit 113 to function as an issue request acquisition unit 1131, a token transmission unit 1132, a payment information receiving unit 1133, a payment processing unit 1134, and an advertisement information transmission unit 1135.

The storage unit 112 stores the payment token generated by the control unit 113 and the user ID acquired from the user terminal 12 in association with each other. The storage unit 112 stores an advertisement DB 1121 in which a store ID, the product ID that identifies the product included in the payment information, or user information which is information about the user is associated with each of the plurality of pieces of advertisement information.

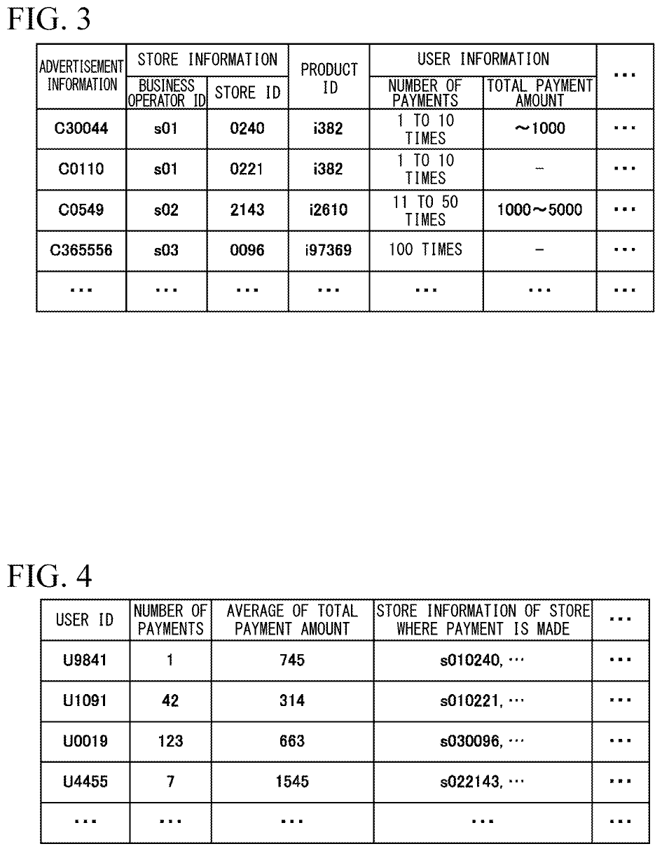

FIG. 3 is a table showing an example of the advertisement DB 1121. The advertisement DB 1121 is constructed by, for example, a business operator operating a store corresponding to the store information. As shown in FIG. 3, it is possible to check that the store information, the product ID, and the user information are associated with the advertisement information in the advertisement DB 1121. The advertisement information is, for example, an advertisement image, an advertisement video, and an advertisement text transmitted to the user terminal 12, but is not limited thereto. The advertisement information may be advertisement data including the advertisement image, the advertisement video, and the advertisement text. The advertisement information is, for example, advertisement information about a product designated in advance by the business operator operating the store corresponding to the store information. By doing so, it is possible to transmit the advertisement information desired by the business operator to the user. The advertisement information may be coupon information.

The store information is information including, for example, the store ID that identifies a store at which a store terminal 13 is installed and a business operator ID as business operator identification information for identifying the business operator operating the store. The user information is, for example, a range of the number of payments in which the user has made a code payment and a range of a total payment amount of the code payment.

As shown in FIG. 3, one piece of store information and one product ID are associated with one piece of advertisement information, but the present invention is not limited thereto. A plurality of pieces of store information and a plurality of product IDs may be associated with one piece of advertisement information.

The storage unit 112 stores a payment history DB 1122 showing a history of the code payment by the user. FIG. 4 is a table showing an example of the payment history DB 1122. As shown in FIG. 4, code payment history information is information in which the user ID, the number of payments in which the user has made the code payment, an average amount when the user has made the code payment, and the store information of the store where the user has made the code payment are associated with each other. The store information of the store where the user has made the code payment may be store information of a store where the number of payments in which the user has made the code payment is relatively large.

The control unit 113 is, for example, a central processing unit (CPU). The control unit 113 executes the payment program stored in the storage unit 112 to function as the issue request acquisition unit 1131, the token transmission unit 1132, the payment information receiving unit 1133, the payment processing unit 1134, and the advertisement information transmission unit 1135. An operation of each unit of the control unit 113 will be described below in detail.

### [Functional Configuration of User Terminal 12]

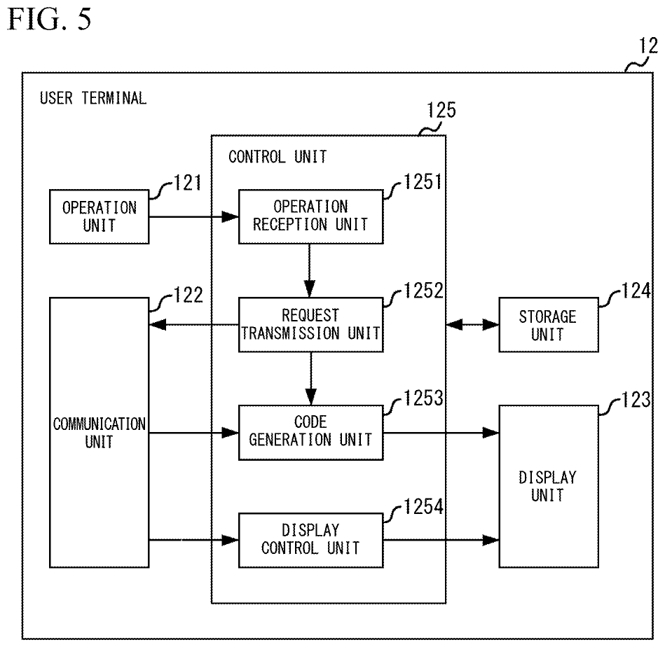

FIG. 5 is a diagram showing a functional configuration of the user terminal 12. The user terminal 12 has an operation unit 121, a communication unit 122, a display unit 123, a storage unit 124, and a control unit 125. The control unit 125 has an operation reception unit 1251, a request transmission unit 1252, a code generation unit 1253, and a display control unit 1254.

The operation unit 121 is an operation device that receives an operation of the user and is, for example, a touch panel provided on a surface of the display unit 123. The operation unit 121 notifies the operation reception unit 1251 of a signal indicating a position touched by the user.

The communication unit 122 is, for example, a wireless communication interface for transmitting and receiving data to and from a base station of a mobile phone network. The communication unit 122 inputs the payment token or the like received from the payment processing device 11 into the code generation unit 1253.

The display unit 123 is a display that displays various types of information. The display unit 123 displays the payment code on the basis of control of the code generation unit 1253.

The storage unit 124 is a storage medium including a ROM, a RAM, and the like. The storage unit 124 stores a program executed by the control unit 125. The storage unit 124 stores a program that causes the control unit 125 to function as the operation reception unit 1251, the request transmission unit 1252, the code generation unit 1253, and the display control unit 1254. The storage unit 124 stores the payment token received from the payment processing device 11, the payment code generated on the basis of the payment token, and the like.

The control unit 125 is, for example, a CPU and executes the program stored in the storage unit 124 to function as the operation reception unit 1251, the request transmission unit 1252, the code generation unit 1253, and the display control unit 1254.

The operation reception unit 1251 specifies an operation content of the user on the basis of the signal input from the operation unit 121. The operation reception unit 1251 notifies the request transmission unit 1252 of the operation content in a case where the specified operation content is an operation for displaying the payment code on the user terminal 12. In a case where the operation reception unit 1251 receives the operation for displaying the payment code on the user terminal 12, the request transmission unit 1252 transmits the user ID and the request for acquiring the payment code to the payment processing device 11 through the communication unit 122.

When the payment token is transmitted from the payment processing device 11, the code generation unit 1253 generates the payment code on the basis of the payment token. The code generation unit 1253 generates the payment code on the basis of a predetermined rule, for example. The code generation unit 1253 causes the display unit 123 to display the generated payment code.

When the payment completion information indicating that the payment has been completed and the advertisement information are received from the payment processing device 11, the display control unit 1254 displays these pieces of information on the same screen of the display unit 123.

### [Functional Configuration of Store Terminal 13]

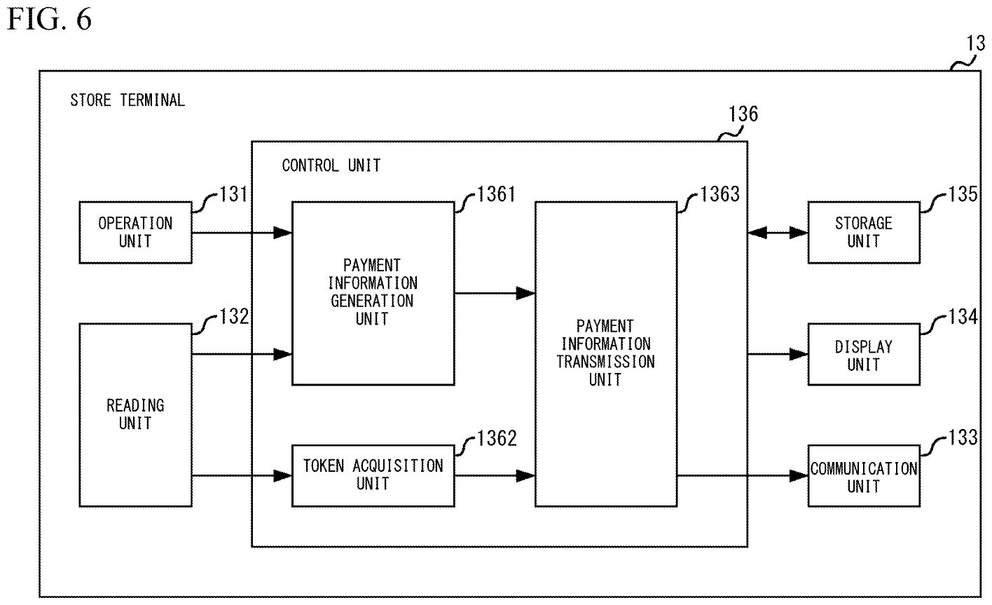

FIG. 6 is a diagram showing a functional configuration of the store terminal 13. The store terminal 13 has an operation unit 131, a reading unit 132, a communication unit 133, a display unit 134, a storage unit 135, and a control unit 136.

The operation unit 131 is an operation device that receives the operation of the user and is, for example, a button for selecting a product to be purchased by the user or a touch panel provided on a surface of the display unit 134.

The reading unit 32 is, for example, a barcode reader and a camera, and reads a barcode attached to the product to be purchased by the user or the payment code displayed by the user terminal 12. The reading unit 132 outputs information indicated by the read barcode and payment code to the control unit 136.

The communication unit 133 is, for example, a communication interface for transmitting and receiving data to and from the payment processing device 11. The communication unit 133 transmits the payment token, the payment information, benefit target product information, and the store ID to the payment processing device 11 according to control of the control unit 136.

The display unit 134 is a display that displays various types of information. The display unit 134 displays, for example, a payment amount.

The storage unit 135 is a storage medium including a ROM, a RAM, and the like. The storage unit 135 stores a program executed by the control unit 136. The storage unit 135 stores a program that causes the control unit 136 to function as a payment information generation unit 1361, a token acquisition unit 1362, and a payment information transmission unit 1363. The storage unit 135 stores a product DB in which the product ID and a price of the product are associated with each other.

The control unit 136 is, for example, a CPU and executes the program stored in the storage unit 135 to function as the payment information generation unit 1361, the token acquisition unit 1362, and the payment information transmission unit 1363.

The payment information generation unit 1361 specifies one or more products to be paid and generates the payment information. Specifically, the payment information generation unit 1361 acquires the product ID which is input by the clerk in the operation unit 131 or is read by the reading unit 132 from the barcode attached to the product to specify a product with the acquired product ID as the product to be paid. The payment information generation unit 1361 refers to the product DB stored in the storage unit 135 to specify the price of the product associated with the acquired product ID. The payment information generation unit 1361 acquires one or more product IDs which are input by the clerk in the operation unit 131 or are read by the reading unit 132 from the barcode attached to the product to sum up prices of the products specified from the product IDs. When the operation unit 131 receives a settlement operation, the payment information generation unit 1361 determines the summed price of the products as the payment amount. The payment information generation unit 1361 generates the payment information including the determined payment amount and one or more acquired product IDs.

The token acquisition unit 1362 acquires information extracted from the payment code as the payment token by the reading unit 132 reading the payment code displayed on the user terminal 12.

When the payment information generation unit 1361 generates the payment information and the token acquisition unit 1362 acquires the payment token, the payment information transmission unit 1363 transmits the payment token, the payment information, and the store ID to the payment processing device 11 through the communication unit 133.

### [Operation of Each Unit of Control Unit 113]

Subsequently, the operation of each unit of the control unit 113 will be described.

The issue request acquisition unit 1131 acquires the user ID of the user of the user terminal 12 and a request for issuing the payment code for the user of the user terminal 12 to make the payment at the store, from the user terminal 12.

When the issue request acquisition unit 1131 acquires the request for acquiring the payment code, the token transmission unit 1132 generates the payment token for generating the payment code. The token transmission unit 1132 stores the user ID acquired by the issue request acquisition unit 1131 and the generated payment token in the storage unit 112 in association with each other. The token transmission unit 1132 transmits the generated payment token to the user terminal 12 that has transmitted the request for acquiring the payment code.

The payment information receiving unit 1133 receives the payment request including the payment token, the store information, and the payment information about a purchase of a product or service by the user at the store, from the store terminal 13 that has read the payment code displayed by the user terminal 12 on the basis of the payment token transmitted by the token transmission unit 1132.

In a case where the payment token stored in the storage unit 112 matches the payment token received by the payment information receiving unit 1133, the payment processing unit 1134 makes the payment on the basis of the user ID which is associated with the payment token and the store information and payment information which are included in the received payment request.

Specifically, the payment processing unit 1134 specifies the user ID stored in association with the payment token in the storage unit 112 and executes processing of withdrawing the payment amount indicated by the payment information from an account of the user specified by the user ID. The payment processing unit 1134 executes processing of depositing the payment amount into an account of the store specified by the received store information. The payment processing unit 1134 may deposit an amount obtained by subtracting a payment fee in the payment processing device 11 from the payment amount into the account of the store. In a case where the payment of the payment amount is completed, the payment processing unit 1134 notifies the store terminal 13 that the payment is completed. The payment processing unit 1134 stores a purchase history of the user at the store, including the store information and the user ID, in the storage unit 112 according to the completion of the payment.

In a case where the payment token stored in the storage unit 112 matches the payment token received by the payment information receiving unit 1133, the advertisement information transmission unit 1135 acquires the advertisement information presented to the user on the basis of the store information or the payment information received by the payment information receiving unit 1133 or the user ID associated with the payment token received by the payment information receiving unit 1133. In a case where the advertisement information is acquired on the basis of the store information received by the payment information receiving unit 1133, the advertisement information transmission unit 1135 acquires the advertisement information including information about a store different from the store where the user makes the payment, information about a business operator different from the business operator operating the store where the user makes the payment, or information about a predetermined product or service, as the advertisement information presented to the user. In a case where the advertisement information is acquired on the basis of the payment information received by the payment information receiving unit 1133 or the user ID associated with the payment token received by the payment information receiving unit 1133, the advertisement information transmission unit 1135 acquires the advertisement information including information about a predetermined store, information about a predetermined business operator, or information about a predetermined product or service, as the advertisement information presented to the user.

Specifically, the advertisement information transmission unit 1135 refers to the advertisement DB 1121 in which the store ID, the product ID included in the payment information, or the user ID is associated with each of the plurality of pieces of advertisement information to acquire the received store information or payment information, or the advertisement information associated with the user information specified on the basis of the user ID related to the received payment token.

For example, in a case where the advertisement information is acquired on the basis of the store information, the advertisement information transmission unit 1135 refers to the advertisement DB 1121 to acquire the advertisement information associated with a business operator code included in the received store information. By doing so, the advertisement information transmission unit 1135 can acquire the advertisement information desired to be distributed by the business operator operating the store at which the store terminal 13 is installed.

In a case where the advertisement information is acquired on the basis of the user ID associated with the payment token received by the payment information receiving unit 1133, the advertisement information transmission unit 1135 may refer to the advertisement DB 1121 and the payment history DB 1122 to acquire the advertisement information on the basis of the number of payments, the total payment amount, or the store information which is associated with the user ID. Specifically, the advertisement information transmission unit 1135 refers to the payment history DB 1122 to specify the number of payments, the average of the total payment amount, or the store information of the store where the payment is made, which is associated with the user ID associated with the payment token received by the payment information receiving unit 1133. The advertisement information transmission unit 1135 refers to the advertisement DB 1121 to acquire the advertisement information corresponding to the specified number of payments, average of the total payment amount, or store information of the store where the payment is made. For example, the advertisement information transmission unit 1135 acquires the advertisement information corresponding to a specific store or business operator for a user who has a large number of payments and a user who has a large balance. By doing so, the advertisement information transmission unit 1135 can acquire the advertisement information effective for the user on the basis of an action history of the user.

The advertisement information transmission unit 1135 may acquire the advertisement information on the basis of the purchase amount of the product or service indicated by the payment information included in the payment request received by the payment information receiving unit 1133. For example, the advertisement information transmission unit 1135 may refer to the advertisement DB 1121 to acquire the advertisement information including the purchase amount of the product or service indicated by the payment information in the range of the total payment amount of the code payment. The advertisement information transmission unit 1135 may acquire different advertisement information between a high-priced purchaser whose payment amount is higher than a first amount and a low-priced purchaser whose payment amount is lower than a second amount or may acquire specific advertisement information (for example, a store campaign advertisement) only for the high-priced purchaser. In a case where the plurality of pieces of advertisement information can be acquired, the advertisement information transmission unit 1135 may narrow down the advertisement information corresponding to the store information or the product 1D included in the payment request. By doing so, the advertisement information transmission unit 1135 can acquire the advertisement information effective for the user on the basis of the purchase amount of the user.

The advertisement information transmission unit 1135 may acquire the advertisement information on the basis of purchase statuses of products or services purchased by the user and another user different from the user. For example, in a case where the advertisement information is acquired on the basis of the purchase status of the product or service purchased by the user, the advertisement information transmission unit 1135 refers to the advertisement DB 1121 to acquire the advertisement associated with the product ID included in the payment information. By doing so, the advertisement information transmission unit 1135 can acquire the advertisement information corresponding to the product purchased by the user.

In a case where the advertisement information is acquired on the basis of the purchase status of the product or service purchased by another user different from the user, the advertisement information transmission unit 1135 may specify another user who has an attribute similar to the attribute of the user. In this case, the storage unit 112 stores user attribute information in which the user ID is associated with the attribute of the user. The advertisement information transmission unit 1135 refers to the user attribute information to specify the user ID associated with the payment token received by the payment information receiving unit 1133 and the user ID of another user who has an attribute similar to the attribute of the user. The advertisement information transmission unit 1135 refers to the advertisement DB 1121 to acquire the advertisement information associated with the product ID of the product or service purchased by the user corresponding to the specified another user ID. By doing so, it is highly possible that the user is also interested in the products purchased by the user and another user who has an attribute similar to the attribute of the user. Therefore, the advertisement information transmission unit 1135 can acquire the advertisement information effective for the user.

The advertisement information transmission unit 1135 may acquire the advertisement information about a store where the code payment by the payment processing device 11 is possible. For example, the storage unit 112 stores code payment correspondence information in which the store information is associated with information indicating whether or not the code payment by the payment processing device 11 is possible at the store of the store information. The advertisement information transmission unit 1135 refers to the code payment correspondence information to specify the store information of a store where the code payment by the payment processing device 11 is possible. The advertisement information transmission unit 1135 refers to the advertisement DB 1121 to acquire the advertisement information associated with the specified store information. In this case, the advertisement information transmission unit 1135 may narrow down the advertisement information to be acquired, on the basis of the business operator ID that constitutes the store information included in the payment request. By doing so, the advertisement information transmission unit 1135 can present, to the user, the advertisement information about the store where the code payment by the payment processing device 11 is possible, which contributes to the spread of the code payment by the payment processing device 11.

The advertisement information transmission unit 1135 may acquire the advertisement information about another store different from a store corresponding to the received store information on the basis of a position of the store. For example, the storage unit 112 stores the store information and store position information indicating a position of the store information in association with each other. The advertisement information transmission unit 1135 specifies another store information existing at a position close to the position of the store information included in the payment request received by the payment information receiving unit 1133. The advertisement information transmission unit 1135 may specify another store information operated by the same business operator as the store information included in the payment request received by the payment information receiving unit 1133. The store information included in the advertisement DB 1121 includes the store information including the same business operator ID as the business operator ID included in the store information included in the payment request received by the payment information receiving unit 1133. The advertisement information transmission unit 1135 refers to the advertisement DB 1121 to specify the store information composed of the business operator ID included in the store information included in the received payment request and a store ID different from the store ID included in the store information included in the received payment request, as another store information operated by the same business operator as the store information included in the received payment request.

The advertisement information transmission unit 1135 refers to the advertisement DB 1121 to specify the advertisement information associated with the specified store information as the advertisement information corresponding to a nearby store at the position of the store corresponding to the received store information. By doing so, the advertisement information transmission unit 1135 can present, to the user, the advertisement information about another store that is operated by the same business operator as the business operator of the store where the user has made the code payment and is different from the store.

The advertisement information transmission unit 1135 may acquire the advertisement information on the basis of a position of the user corresponding to the user ID related to the payment token. For example, the storage unit 112 stores the store information and the store position information indicating the position of the store information in association with each other and also stores the user ID and terminal position information indicating a position of the user terminal 12 corresponding to the user ID in association with each other. The advertisement information transmission unit 1135 refers to the storage unit 112 to acquire the terminal position information associated with the user ID corresponding to the payment token received by the payment information receiving unit 1133. The advertisement information transmission unit 1135 specifies the store information associated with the store position information indicating a position relatively close to the position indicated by the acquired terminal position information. The advertisement information transmission unit 1135 refers to the advertisement DB 1121 to acquire the advertisement information associated with the specified store information. By doing so, the advertisement information transmission unit 1135 can present, to the user, the advertisement information corresponding to the store close to the position of the user.

The advertisement information transmission unit 1135 associates the payment completion information indicating that the payment has been completed with the acquired advertisement information, transmits the associated information to the user terminal 12, and displays the payment completion information and the advertisement information on the same screen of the user terminal 12. By doing so, the advertisement information transmission unit 1135 can increase the possibility that the user visually recognizes the advertisement information.

The advertisement information transmission unit 1135 may store, in the storage unit 112, a transmission history of the advertisement information to the user terminal 12, including the acquired advertisement information and the store information associated with the advertisement information in the advertisement DB 1121. The control unit 113 of the payment processing device 11 may function as an effect measurement unit and may measure an effect of the advertisement information transmitted by the advertisement information transmission unit 1135 on the basis of the purchase history at the store of the user, including the store information and the user ID, stored in the storage unit 112 by the payment processing unit 1134 and the transmission history stored in the storage unit 112 by the advertisement information transmission unit 1135.

### [Operation Sequence]

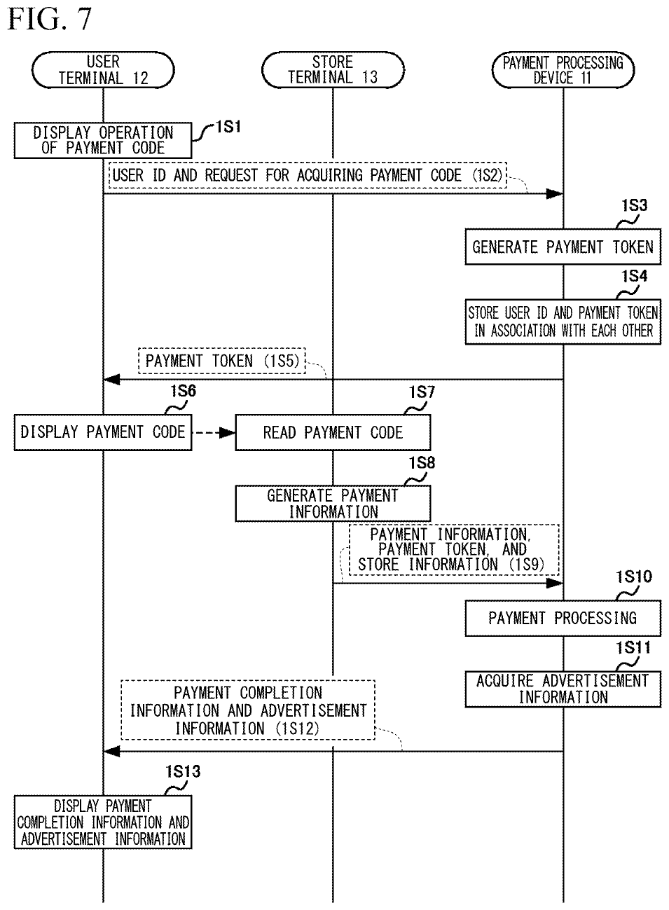

FIG. 7 is an operation sequence diagram of the payment system 1S.

The sequence diagram shown in FIG. 7 starts from a display operation of the payment code on the user terminal 12 by the user (1S1). The request transmission unit 1252 transmits the user ID and the request for acquiring the payment code to the payment processing device 11 (1S2).

The issue request acquisition unit 1131 of the payment processing device 11 acquires the user ID and the request for issuing the payment code from the user terminal 12. When the user ID and the request for acquiring the payment code are acquired, the token transmission unit 1132 of the payment processing device 11 generates the payment token for generating the payment code (1S3). The token transmission unit 1132 stores the generated payment token and the user ID in the storage unit 112 in association with each other (1S4). The token transmission unit 1132 transmits the generated payment token to the user terminal 12 that has transmitted the request for acquiring the payment code (1S5).

The code generation unit 1253 of the user terminal 12 generates the payment code on the basis of the payment token received from the payment processing device 11 and displays the generated payment code on the display unit 123 (1S6). At the store, the user presents the payment code displayed on the user terminal 12, and the reading unit 132 of the store terminal 13 reads the payment code (1S7).

The payment information generation unit 1361 of the store terminal 13 specifies the price of the product on the basis of the product ID input by the clerk in the operation unit 131 or the product ID read from the barcode attached to the product by the reading unit 132 and generates the payment information (1S8). The payment information transmission unit 1363 of the store terminal 13 transmits the payment information generated in 1S8, the payment token included in the payment code read in 1S7, and the store information to the payment processing device 11 (1S9).

Subsequently, the payment information receiving unit 1133 receives the payment request including the payment token, the store information, and the payment information from the store terminal 13. In a case where the payment token stored in the storage unit 112 matches the received payment token, the payment processing unit 1134 performs the payment processing on the basis of the user ID which is associated with the payment token and the store information and payment information which are included in the received payment request (1S10).

In a case where the payment token stored in the storage unit 112 matches the received payment token, the advertisement information transmission unit 1135 acquires the advertisement information presented to the user on the basis of the store information or payment information received by the payment information receiving unit 1133 or the user ID associated with the payment token received by the payment information receiving unit 1133 (1S11). The advertisement information transmission unit 1135 transmits the payment completion information indicating that the payment has been completed and the acquired advertisement information to the user terminal 12 (1S12).

The display control unit 1254 of the user terminal 12 causes the display unit 123 to display the payment completion information and the advertisement information received from the payment processing device 11 (1S13).

### Modification Example 1

In the above description, the payment processing device 11 displays the payment completion information and the advertisement information on the same screen of the user terminal 12, but the present invention is not limited thereto. The payment processing device 11 may display the advertisement information in a case where the payment code is displayed on the user terminal 12. In this case, the advertisement information transmission unit 1135 may acquire the advertisement information on the basis of the user information specified from the user ID acquired by the issue request acquisition unit 1131 together with the request for acquiring the payment code and may transmit the advertisement information together with the payment token to the user terminal 12 to display the advertisement information on the user terminal 12.

### Modification Example 2

The payment processing device 11 acquires the advertisement information at the timing when the payment request is received, but the present invention is not limited thereto. The payment processing device 11 may refer to the advertisement DB 1121 at a timing when the issue request acquisition unit 1131 acquires the user ID together with the request for acquiring the payment code to acquire one or more pieces of advertisement information on the basis of the user information specified from the user ID. At the timing of receiving the payment request, the payment processing device 11 may acquire the advertisement information transmitted to the user terminal 12 from the acquired advertisement information on the basis of the store information or the payment information included in the payment request.

### [Effect of Payment System 1S]

As described above, when the user ID and the request for issuing the payment code for the user to make the payment at the store are acquired from the user terminal 12, the payment processing device 11 stores the user ID and the payment token for generating the payment code in the storage unit 112 in association with each other and transmits the payment token to the user terminal 12. The payment processing device 11 receives the payment token, the store information for identifying the store, and the payment information about the purchase of the product or service by the user at the store from the store terminal 13 that has read the payment code displayed by the user terminal 12 on the basis of the transmitted payment token, acquires the advertisement information presented to the user on the basis of the received store information or payment information or the user ID associated with the payment token in a case where the payment token stored in the storage unit 112 matches the received payment token, and transmits the advertisement information to the user terminal 12. By doing so, the payment processing device 11 can present the information to the user according to the purchase status of the user.

### Second Embodiment

### [Outline of Payment System 2S]

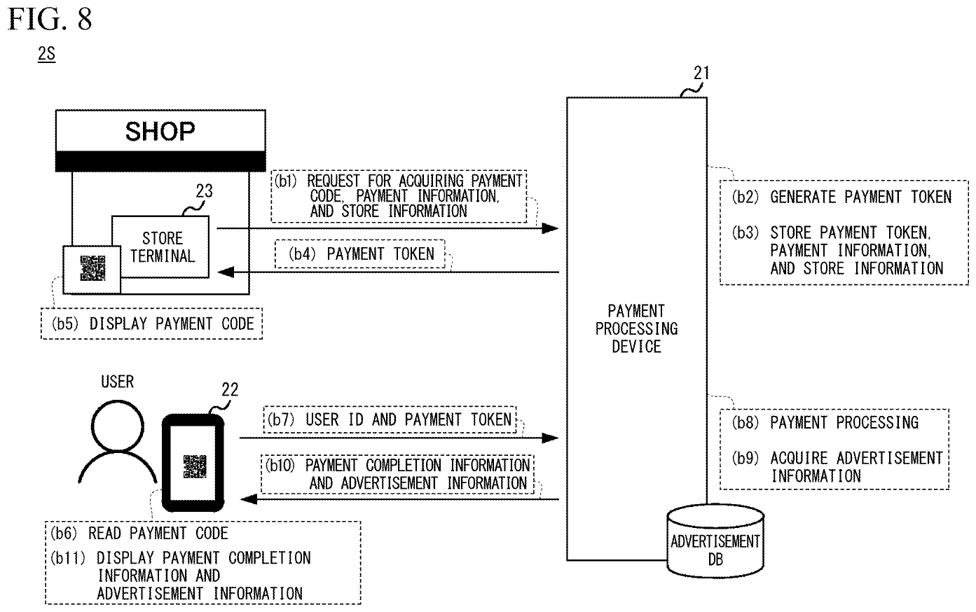

FIG. 8 is a diagram showing an outline of a payment system 2S. The payment system 2S is a system that displays a payment code on a user terminal in response to a request from the user terminal possessed by a user and makes a payment according to reading of the payment code on a store in a case where the user purchases a product at the store. The payment code is a text or image that can be read by the user terminal 22 and is a code used at the time of the payment.

The payment system 2S includes a payment processing device 21, a user terminal 22, and a store terminal 23. The payment processing device 21 is a server that makes the payment of a purchase amount. The payment processing device 21 also functions as an information processing device that presents advertisement information as presentation information to the user at the time of the payment of the purchase amount. The user terminal 22 is an information terminal used by the user and is, for example, a smartphone, a tablet, or a personal computer. The store terminal 23 is, for example, a POS terminal.

Hereinafter, a flow until the advertisement information is presented to the user will be described with reference to FIG. 8.

The user moves to the store and purchases the product including a target product at the store. In a case where the user performs accounting at the store, a clerk at the store reads barcodes attached to products to be purchased on the store terminal 23 and generates payment information indicating a total amount of the products to be purchased by the user on the store terminal 23.

The clerk performs, on the store terminal 23, an operation for displaying the payment code on the store terminal 23. The store terminal 23 transmits a request for acquiring the payment code, the payment information, and store information for identifying the store to the payment processing device 21 ((IA) in FIG. 8).

When the request for acquiring the payment code, the payment information, and the store information are received from the store terminal 23, the payment processing device 21 generates a payment token ((b2) in FIG. 8). The payment token is a data string used when the store terminal 23 generates the payment code presented to the user by the store terminal 23. The payment token may be generated only in a case of a specific store specified by the store information. The payment processing device 21 stores the generated payment token, the payment information, and the store information in association with each other in a storage medium ((b3) in FIG. 8).

The payment processing device 21 transmits the generated payment token to the store terminal 23 ((b4) in FIG. 8). The payment processing device 21 may encrypt the payment token and then transmit the encrypted payment token to the store terminal 23.

The store terminal 23 generates and displays the payment code on the basis of the received payment token ((b5) in FIG. 8).

The user terminal 22 reads the payment code displayed on the store terminal 23, for example, by an operation of the user ((b6) in FIG. 8). The user terminal 22 transmits a user ID and the payment token indicated by the read payment code to the payment processing device 21 ((b7) in FIG. 8).

When the user ID and the payment token is received from the user terminal 22, the payment processing device 21 determines whether or not the received payment token matches the payment token transmitted to the store terminal 23. In a case where determination is made that the payment tokens match, the payment processing device 21 executes payment processing on the basis of the payment information and the store information stored in association with the received payment token ((b8) in FIG. 8).

In a case where the determination is made that the payment tokens match, the payment processing device 21 refers to an advertisement DB (database) in which the store information, a product ID that identifies the product, or the user ID is associated with each of a plurality of pieces of advertisement information to acquire the advertisement information presented to the user ((b9) in FIG. 8).

The payment processing device 21 transmits payment completion information indicating that the payment has been completed and the acquired advertisement information to the user terminal 22 ((b10) in FIG. 8). The user terminal 22 displays the received payment completion information and the advertisement information ((b11) in FIG. 8).

With the operation as described above, the payment system 2S can present the advertisement information effective for the user on the basis of a purchase status of the user, a store visit status, or the user ID.

Details of configurations of the payment processing device 21, the user terminal 22, and the store terminal 23 will be described below.

### [Functional Configuration of Payment Processing Device 21]

The configuration of the payment processing device 21 according to the second embodiment is the same as that of the payment processing device 11 according to the first embodiment shown in FIG. 2. That is, as shown in FIG. 2, the payment processing device 21 has a communication unit 211, a storage unit 212, and a control unit 213.

In the second embodiment, the communication unit 211 is a communication interface for transmitting and receiving data to and from the user terminal 22 and the store terminal 23 through a network such as the Internet.

Similar to the first embodiment, the storage unit 212 stores a program executed by the control unit 213. That is, the storage unit 212 stores a payment program that causes the control unit 213 to function as an issue request acquisition unit 2131, a token transmission unit 2132, a payment information receiving unit 2133, a payment processing unit 2134, and an advertisement information transmission unit 2135.

Similar to the first embodiment, the storage unit 212 stores the payment token generated by the control unit 213, the store information acquired from the store terminal 23, and the payment information in association with each other. The storage unit 212 stores an advertisement DB 2121 in which the store ID, the product ID that identifies the product, or user information which is information about the user is associated with each of the plurality of pieces of advertisement information.

An example of a content of the advertisement DB2121 is the same as that of the first embodiment and is as shown in FIG. 3. The advertisement DB 2121 is constructed by, for example, a business operator operating a store corresponding to the store information. As shown in FIG. 3, it is possible to check that the store information, the product ID, and the user information are associated with the advertisement information in the advertisement DB 2121. The advertisement information is, for example, an advertisement image, an advertisement video, and an advertisement text transmitted to the user terminal 22, but is not limited thereto. The advertisement information may be advertisement data including the advertisement image, the advertisement video, and the advertisement text.

The store information is information including, for example, the store ID that identifies a store at which a store terminal 23 is installed and a business operator ID as business operator identification information for identifying the business operator operating the store. The user information is, for example, a range of the number of payments in which the user has made a code payment and a range of a total payment amount of the code payment.

Similar to the first embodiment, the storage unit 212 according to the second embodiment stores a payment history DB 2122 showing a history of the code payment by the user as shown in FIG. 4.

Similar to the first embodiment, the control unit 213 executes the payment program stored in the storage unit 212 to function as the issue request acquisition unit 2131, the token transmission unit 2132, the payment information receiving unit 2133, the payment processing unit 2134, and the advertisement information transmission unit 2135. The operation of each unit of the control unit 213 will be described below in detail.

### [Functional Configuration of User Terminal 22]

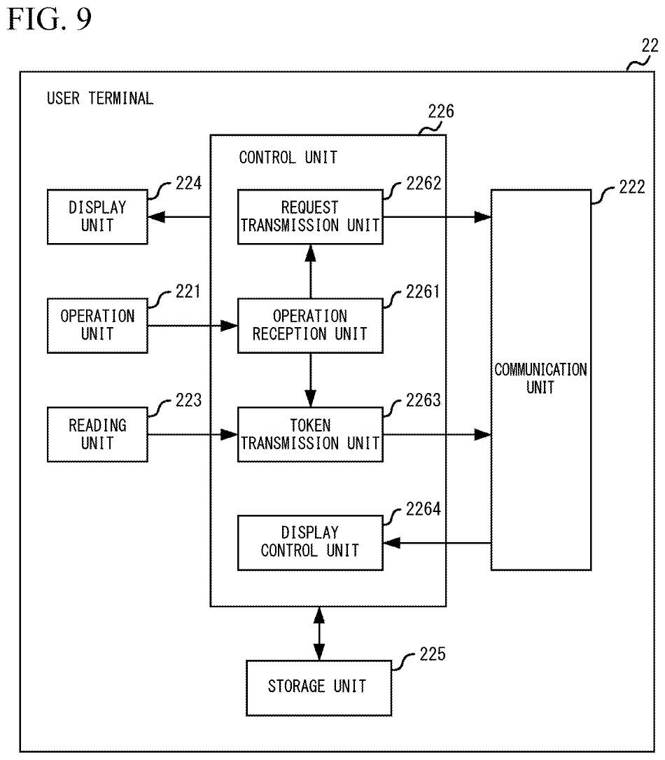

FIG. 9 is a diagram showing a functional configuration of the user terminal 22. The user terminal 22 has an operation unit 221, a communication unit 222, a reading unit 223, a display unit 224, a storage unit 225, and a control unit 226. The control unit 226 has an operation reception unit 2261, a request transmission unit 2262, a token transmission unit 2263, and a display control unit 2264.

The operation unit 221 is an operation device that receives an operation of the user and is, for example, a touch panel provided on a surface of the display unit 224. The operation unit 221 notifies the operation reception unit 2261 of a signal indicating a position touched by the user.

The communication unit 222 is, for example, a wireless communication interface for transmitting and receiving data to and from a base station of a mobile phone network. The communication unit 222 transmits the acquired payment token or the like to the payment processing device 21.

The reading unit 223 is, for example, a camera. The reading unit 223 reads the payment code displayed on the store terminal 23.

The display unit 224 is a display that displays various types of information.

The storage unit 225 is a storage medium including a ROM, a RAM, and the like. The storage unit 225 stores a program executed by the control unit 226. The storage unit 225 stores a program that causes the control unit 226 to function as the operation reception unit 2261, the request transmission unit 2262, the token transmission unit 2263, and the display control unit 2264.

The control unit 226 is, for example, a CPU and executes the program stored in the storage unit 225 to function as the operation reception unit 2261, the request transmission unit 2262, the token transmission unit 2263, and the display control unit 2264.

The operation reception unit 2261 specifies an operation content of the user on the basis of the signal input from the operation unit 221. In a case where the specified operation content is an operation for reading the payment code, the operation reception unit 2261 notifies the token transmission unit 2263 of the operation content.

In a case where the operation reception unit 2261 receives the operation for reading the payment code, the token transmission unit 2263 causes the reading unit 223 to read the payment code displayed on the store terminal 23. The token transmission unit 2263 acquires information extracted from the payment code by the reading unit 223 as the payment token. The token transmission unit 2263 transmits the acquired payment token and the user ID to the payment processing device 21 through the communication unit 222.

When the payment completion information indicating that the payment has been completed and the advertisement information are received from the payment processing device 21, the display control unit 2264 displays these pieces of information on the same screen of the display unit 224.

### [Functional Configuration of Store Terminal 23]

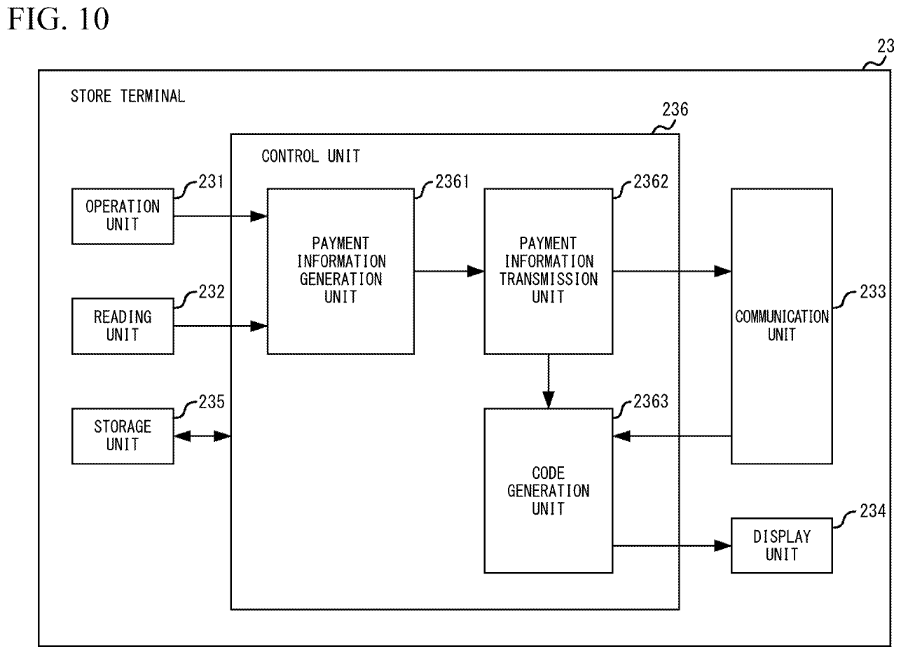

FIG. 10 is a diagram showing a functional configuration of the store terminal 23. The store terminal 23 has an operation unit 231, a reading unit 232, a communication unit 233, a display unit 234, a storage unit 235, and a control unit 236.

The operation unit 231 is an operation device that receives the operation of the user and is, for example, a button for selecting a product to be purchased by the user or a touch panel provided on a surface of the display unit 234.

The reading unit 232 is, for example, a barcode reader and reads the barcode attached to the product to be purchased by the user. The reading unit 232 outputs information indicated by the read barcode to the control unit 236.

The communication unit 233 is, for example, a communication interface for transmitting and receiving data to and from the payment processing device 21. The communication unit 233 transmits the request for acquiring the payment code, the payment information, and the store information to the payment processing device 21 according to control of the control unit 236. The communication unit 233 receives the payment token from the payment processing device 21.

The display unit 234 is a display that displays various types of information. The display unit 234 displays, for example, the payment amount or the payment code.

The storage unit 235 is a storage medium including a ROM, a RAM, and the like. The storage unit 235 stores a program executed by the control unit 236. The storage unit 235 stores a program that causes the control unit 236 to function as a payment information generation unit 2361, a payment information transmission unit 2362, and a code generation unit 2363. The storage unit 235 stores a product DB in which the product ID and a price of the product are associated with each other.

The control unit 236 is, for example, a CPU and executes the program stored in the storage unit 235 to function as the payment information generation unit 2361, the payment information transmission unit 2362, and the code generation unit 2363.

The payment information generation unit 2361 specifies one or more products to be paid and generates the payment information. Specifically, the payment information generation unit 2361 acquires the product ID which is input by the clerk in the operation unit 231 or is read by the reading unit 232 from the barcode attached to the product to specify a product with the acquired product ID as the product to be paid. The payment information generation unit 2361 refers to the product DB stored in the storage unit 235 to specify the price of the product associated with the acquired product ID. The payment information generation unit 2361 acquires one or more product IDs which are input by the clerk in the operation unit 231 or are read by the reading unit 232 from the barcode attached to the product to sum up prices of the products specified from the product IDs. When the operation unit 231 receives a settlement operation, the payment information generation unit 2361 determines the summed price of the products as the payment amount. The payment information generation unit 2361 generates the payment information including the determined payment amount and one or more acquired product IDs.

When the payment information generation unit 2361 generates the payment information, the payment information transmission unit 2362 transmits the request for acquiring the payment code, the payment information, and the store information to the payment processing device 21 through the communication unit 233.

When the payment token is transmitted from the payment processing device 21, the code generation unit 2363 generates the payment code on the basis of the payment token. The code generation unit 2363 generates the payment code on the basis of a predetermined rule, for example. The code generation unit 2363 causes the display unit 234 to display the generated payment code.

### [Operation of Each Unit of Control Unit 213]

Subsequently, the operation of each unit of the control unit 213 will be described.

The issue request acquisition unit 2131 acquires the store information, the payment information including an amount corresponding to the payment made by the user at the store, and the request for issuing the payment code for the user of the user terminal 22 to make the payment at the store, from the store terminal 23.

When the request for acquiring the payment code is received together with the payment information and the store information from the store terminal 23, the token transmission unit 2132 generates the payment token for generating the payment code. The token transmission unit 2132 stores the generated payment token, the payment information, and the store information in the storage unit 212 in association with each other. The token transmission unit 2132 transmits the generated payment token to the store terminal 23 that has transmitted the request for acquiring the payment code. The token transmission unit 2132 receives the request for acquiring the payment code together with the payment information and the store information from the store terminal 23. However, a timing of receiving the payment information and the store information may be different from a timing of receiving the request for acquiring the payment code. The token transmission unit 2132 may generate the payment token only in a case where the store indicated by the store information is a specific store.

The payment information receiving unit 2133 receives the payment token and the user ID from the user terminal 22 that has read the payment code displayed by the store terminal 23 on the basis of the payment token. The payment information receiving unit 2133 may receive the store information together with the payment token and the user ID from the user terminal 22. For example, the store terminal 23 displays the store information or a code indicating the store information and the user terminal 22 reads the store information or reads the code and extracts the store information from the code to transmit the store information to the payment processing device 21.

In a case where the payment token stored in the storage unit 212 matches the payment token received by the payment information receiving unit 2133, the payment processing unit 2134 makes the payment on the basis of the store information and the payment information stored in the storage unit 212 in association with the payment token.

Specifically, the payment processing unit 2134 specifies the store information and the payment information in the storage unit 212 in association with the received payment token. The payment processing unit 2134 executes processing of withdrawing the payment amount indicated by the specified payment information from an account of the user specified by the user ID received together with the payment token. The payment processing unit 2134 executes processing of depositing the payment amount into an account of the store specified by the specified store information. The payment processing unit 2134 may deposit an amount obtained by subtracting a payment fee in the payment processing device 21 from the payment amount into the account of the store. In a case where the payment of the payment amount is completed, the payment processing unit 2134 notifies the store terminal 23 that the payment is completed. The payment processing unit 2134 stores a purchase history of the user at the store, including the store information and the user ID, in the storage unit 212 according to the completion of the payment.

In a case where the payment token stored in the storage unit 212 matches the payment token received by the payment information receiving unit 2133, the advertisement information transmission unit 2135 acquires the advertisement information presented to the user on the basis of the received user ID or the store information or payment information stored in the storage unit 212 in association with the received payment token. In a case where the advertisement information is acquired on the basis of the store information stored in the storage unit 212 in association with the payment token, the advertisement information transmission unit 2135 acquires the advertisement information including information about a store different from the store where the user makes the payment, information about a business operator different from the business operator operating the store where the user makes the payment, or information about a predetermined product or service, as the advertisement information presented to the user. In a case where the advertisement information is acquired on the basis of the payment information stored in the storage unit 212 in association with the payment token or the received user ID, the advertisement information transmission unit 2135 acquires the advertisement information including information about a predetermined store, information about a predetermined business operator, or information about a predetermined product or service, as the advertisement information presented to the user.

Specifically, the advertisement information transmission unit 2135 refers to the advertisement DB2121 in which the store ID, the product ID, or the user information as the information about the user is associated with each of the plurality of pieces of advertisement information to acquire the received store information or payment information, or the advertisement information associated with the user information specified on the basis of the user ID related to the received payment token.

For example, in a case where the advertisement information is acquired on the basis of the store information, the advertisement information transmission unit 2135 refers to the advertisement DB 2121 to acquire the advertisement information associated with a business operator code included in the store information corresponding to the received payment token. By doing so, the advertisement information transmission unit 2135 can acquire the advertisement information desired to be distributed by the business operator operating the store at which the store terminal 23 is installed.

In a case where the advertisement information is acquired on the basis of the user information, the advertisement information transmission unit 2135 may refer to the advertisement DB2121 and the payment history DB2122 to acquire the advertisement information on the basis of the number of payments and the total payment amount included in the user information associated with the received user ID and the store information corresponding to the received payment token. Specifically, the advertisement information transmission unit 2135 refers to the payment history DB 2122 to specify the number of payments, the average of the total payment amount, or the store information of the store where the payment is made, which is associated with the user ID associated with the payment token received by the payment information receiving unit 2133. Then, the advertisement information transmission unit 2135 refers to the advertisement DB2121 to acquire the advertisement information corresponding to the specified number of payments, average of the total payment amount, or store information of the store where the payment is made. For example, the advertisement information transmission unit 2135 acquires the advertisement information corresponding to a specific store or business operator for a user who has a large number of payments and a user who has a large balance. By doing so, the advertisement information transmission unit 2135 can acquire the advertisement information effective for the user on the basis of an action history of the user.

The advertisement information transmission unit 2135 may acquire the advertisement information on the basis of the purchase amount of the product or service indicated by the payment information corresponding to the payment token received by the payment information receiving unit 2133. For example, the advertisement information transmission unit 2135 may refer to the advertisement DB2121 to acquire the advertisement information including the purchase amount of the product or service indicated by the payment information corresponding to the received payment token in the range of the total payment amount of the code payment. The advertisement information transmission unit 2135 may acquire different advertisement information between a high-priced purchaser whose payment amount is higher than a first amount and a low-priced purchaser whose payment amount is lower than a second amount or may acquire specific advertisement information (for example, a store campaign advertisement) only for the high-priced purchaser. In a case where the plurality of pieces of advertisement information can be acquired, the advertisement information transmission unit 2135 may narrow down the advertisement information corresponding to the store information or the product ID included in the payment request. By doing so, the advertisement information transmission unit 2135 can acquire the advertisement information effective for the user on the basis of the purchase amount of the user.

The advertisement information transmission unit 2135 may acquire the advertisement information on the basis of purchase statuses of products or services purchased by the user and another user different from the user. For example, in a case where the advertisement information is acquired on the basis of the purchase status of the product or service purchased by the user, the advertisement information transmission unit 2135 refers to the advertisement DB 2121 to acquire the advertisement associated with the product ID included in the payment information. By doing so, the advertisement information transmission unit 2135 can acquire the advertisement information corresponding to the product purchased by the user.

In a case where the advertisement information is acquired on the basis of the purchase status of the product or service purchased by another user different from the user, the advertisement information transmission unit 2135 may specify another user who has an attribute similar to the attribute of the user. In this case, the storage unit 212 stores user attribute information in which the user ID is associated with the attribute of the user. The advertisement information transmission unit 2135 refers to the user attribute information to specify the user ID associated with the payment token received by the payment information receiving unit 2133 and the user ID of another user who has an attribute similar to the attribute of the user. The advertisement information transmission unit 2135 refers to the advertisement DB 2121 to acquire the advertisement information associated with the product ID of the product or service purchased by the user corresponding to the specified another user ID. By doing so, it is highly possible that the user is also interested in the products purchased by the user and another user who has an attribute similar to the attribute of the user. Therefore, the advertisement information transmission unit 2135 can acquire the advertisement information effective for the user.

The advertisement information transmission unit 2135 may acquire the advertisement information about a store where the code payment by the payment processing device 21 is possible. For example, the storage unit 212 stores code payment correspondence information in which the store information is associated with information indicating whether or not the code payment by the payment processing device 21 is possible at the store of the store information. The advertisement information transmission unit 2135 refers to the code payment correspondence information to specify the store information of a store where the code payment by the payment processing device 21 is possible. Then, the advertisement information transmission unit 2135 refers to the advertisement DB 2121 to acquire the advertisement information associated with the specified store information. In this case, the advertisement information transmission unit 2135 may narrow down the advertisement information to be acquired, on the basis of the business operator ID that constitutes the store information corresponding to the received payment token. By doing so, the advertisement information transmission unit 2135 can present, to the user, the advertisement information about the store where the code payment by the payment processing device 21 is possible, which contributes to the spread of the code payment by the payment processing device 21.

The advertisement information transmission unit 2135 may acquire the advertisement information about another store different from a store corresponding to the received store information on the basis of a position of the store. For example, the storage unit 212 stores the store information and store position information indicating a position of the store information in association with each other. The advertisement information transmission unit 2135 specifies another store information existing at a position close to the position of the store information included in the payment request received by the payment information receiving unit 2133. The advertisement information transmission unit 2135 may specify another store information operated by the same business operator as the store information included in the payment request received by the payment information receiving unit 2133. The store information included in the advertisement DB 2121 includes the store information including the same business operator ID as the business operator ID included in the store information included in the payment request received by the payment information receiving unit 2133. The advertisement information transmission unit 2135 refers to the advertisement DB 2121 to specify the store information composed of the business operator ID included in the store information included in the received payment request and a store ID different from the store ID included in the store information included in the received payment request, as another store information operated by the same business operator as the store information included in the received payment request.

The advertisement information transmission unit 2135 refers to the advertisement DB 2121 to specify the advertisement information associated with the specified store information as the advertisement information corresponding to a nearby store at the position of the store corresponding to the received store information. By doing so, the advertisement information transmission unit 2135 can present, to the user, the advertisement information about another store that is operated by the same business operator as the business operator of the store where the user has made the code payment and is different from the store.

The advertisement information transmission unit 2135 may acquire the advertisement information on the basis of a position of the user corresponding to the user ID related to the payment token. For example, the storage unit 212 stores the store information and the store position information indicating the position of the store information in association with each other and also stores the user ID and terminal position information indicating a position of the user terminal 22 corresponding to the user ID in association with each other. The advertisement information transmission unit 2135 refers to the storage unit 212 to acquire the terminal position information associated with the user ID received by the payment information receiving unit 2133. The advertisement information transmission unit 2135 specifies the store information associated with the store position information indicating a position relatively close to the position indicated by the acquired terminal position information. The advertisement information transmission unit 2135 refers to the advertisement DB 2121 to acquire the advertisement information associated with the specified store information. By doing so, the advertisement information transmission unit 2135 can present, to the user, the advertisement information corresponding to the store close to the position of the user.

The advertisement information transmission unit 2135 associates the payment completion information indicating that the payment has been completed with the acquired advertisement information, transmits the associated information to the user terminal 22, and displays the payment completion information and the advertisement information on the same screen of the user terminal 22. By doing so, the advertisement information transmission unit 2135 can increase the possibility that the user visually recognizes the advertisement information.

The advertisement information transmission unit 2135 may store, in the storage unit 212, a transmission history of the advertisement information to the user terminal 22, including the acquired advertisement information and the store information associated with the advertisement information in the advertisement DB 2121. The control unit 213 of the payment processing device 21 may function as an effect measurement unit and may measure an effect of the advertisement information transmitted by the advertisement information transmission unit 2135 on the basis of the purchase history at the store of the user, including the store information and the user ID, stored in the storage unit 212 by the payment processing unit 2134 and the transmission history stored in the storage unit 212 by the advertisement information transmission unit 2135.

### [Operation Sequence]

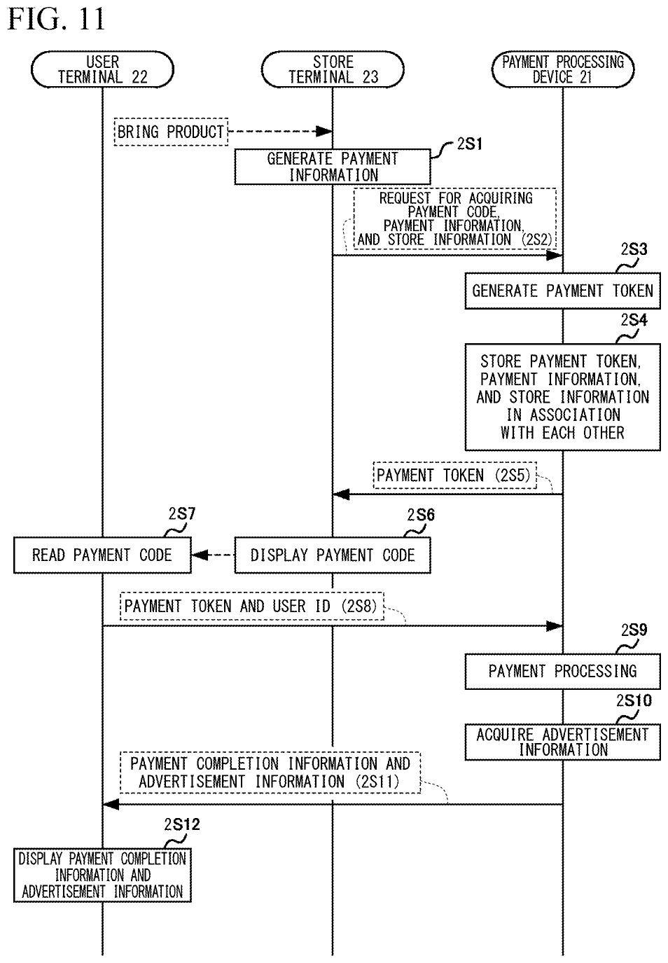

FIG. 11 is an operation sequence diagram of the payment system 2S.

The sequence diagram shown in FIG. 11 starts from a point where the user selects a product to be purchased at the store and brings the selected product to the clerk who uses the store terminal 23. The payment information generation unit 2361 of the store terminal 23 acquires the product ID input by the clerk in the operation unit 231 or the product ID read by the reading unit 232 from the barcode attached to the product and specifies the price of the product associated with the product ID to calculate the payment amount. The payment information generation unit 2361 generates the payment information including the payment amount (2S1).

The payment information transmission unit 2362 transmits the request for acquiring the payment code, the generated payment information, and the store information to the payment processing device 21 (2S2).

When the request for acquiring the payment code, the payment information, and the store information are acquired, the token transmission unit 2132 of the payment processing device 21 generates the payment token for generating the payment code (2S3). The token transmission unit 2132 stores the generated payment token, the payment information, and the store information in the storage unit 212 in association with each other (2S4). The token transmission unit 2132 transmits the generated payment token to the store terminal 23 that has transmitted the request for acquiring the payment code (2S5).

The code generation unit 2363 of the store terminal 23 generates the payment code on the basis of the payment token received from the payment processing device 21 and displays the generated payment code on the display unit 234 (2S6). The user operates the user terminal 22 to cause the user terminal 22 to read the payment code displayed on the store terminal 23 (2S7). The token transmission unit 2263 of the user terminal 22 transmits the payment token obtained from the payment code and the user ID to the payment processing device 21 (2S8).

Subsequently, the payment information receiving unit 2133 receives the payment token and the user ID from the user terminal 22. In a case where the payment token stored in the storage unit 212 matches the received payment token, the payment processing unit 2134 performs the payment processing on the basis of the received user ID and the store information and payment information stored in the storage unit 212 in association with the received payment token (2S9).

In a case where the payment token stored in the storage unit 212 matches the received payment token, the advertisement information transmission unit 2135 acquires the advertisement information presented to the user on the basis of the store information or payment information stored in the storage unit 212 in association with the payment token or the received user ID (2S10). The advertisement information transmission unit 2135 transmits the payment completion information indicating that the payment has been completed and the acquired advertisement information to the user terminal 22 (2S11).

The display control unit 2264 of the user terminal 22 causes the display unit 224 to display the payment completion information and the advertisement information received from the payment processing device 21 (2S12).

### Modification Example 4

In the above description, the store terminal 23 makes the request for acquiring the payment code to the payment processing device 21 when the user purchases the product, but the present invention is not limited thereto. For example, in a case where only products with the same amount are handled at the store and the purchase amount of the product of the user is constant, the store terminal 23 may transmit in advance the payment information and the request for acquiring the payment code to the payment processing device 21 before the user purchases the product.

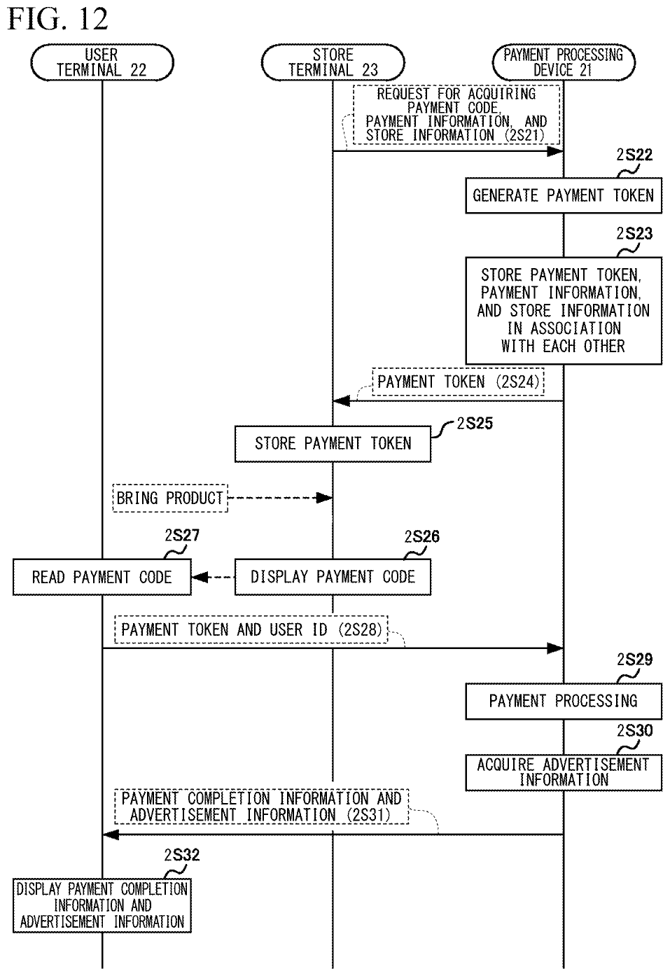

FIG. 12 is an operation sequence diagram of the payment system 2S when the store terminal 23 performs the request for acquiring the payment code before the user purchases the product.

As shown in FIG. 12, first, the payment information transmission unit 2362 transmits the request for acquiring the payment code, the payment information, and the store information to the payment processing device 21 (2S21).

When the payment information, the store information, and the request for acquiring the payment code are received from the store terminal 23, the token transmission unit 2132 of the payment processing device 21 generates the payment token (2S22). The token transmission unit 2132 stores the generated payment token, the payment information, and the store information in the storage unit 212 in association with each other (2S23). The token transmission unit 2132 transmits the generated payment token to the store terminal 23 that has transmitted the request for acquiring the payment code (2S24).

When the payment token is received from the payment processing device 21, the code generation unit 2363 stores the payment token in the storage unit 235 (2S25).

At the store, the user selects the product to be purchased and brings the selected product to the clerk who uses the store terminal 23. As described above, only products having the same amount are handled at the store and the purchase amount of the user is always constant regardless of types of the products. Therefore, the code generation unit 2363 of the store terminal 23 generates the payment code on the basis of the payment token stored in the storage unit 235 and displays the generated payment code on the display unit 234 (2S26). The user operates the user terminal 22 to cause the user terminal 22 to read the payment code displayed on the store terminal 23 (2S27). The token transmission unit 2263 of the user terminal 22 transmits the payment token obtained from the payment code and the user ID to the payment processing device 21 (2S28).

The payment information receiving unit 2133 receives the payment token and the user ID from the user terminal 22. After that, the payment processing unit 2134 and the advertisement information transmission unit 2135 perform the same processing as the processing of 2S9 to 2S12 shown in FIG. 11 to give the user a benefit (2S29 to 2S32).

In this sequence, the payment information transmission unit 2362 transmits the request for acquiring the payment code, the payment amount, and the store information to the payment processing device 21, and the token transmission unit 2132 stores the generated payment token and the received payment amount and store information in the storage unit 212 in association with each other. However, the present invention is not limited thereto. For example, in a case where the user performs an operation of reading the payment code, the user terminal 22 may receive an input of the payment amount. In this case, the payment information transmission unit 2362 may transmit the request for acquiring the payment code and the store information to the payment processing device 21 without transmitting the payment amount, and the token transmission unit 2132 may store the generated payment token and the received store information in the storage unit 212 in association with each other. The token transmission unit 2263 of the user terminal 22 may receive the payment amount from the user and may transmit the payment token obtained from the read payment code, the user ID, and the payment information including the received payment amount to the payment processing device 21. The payment processing unit 2134 makes the payment on the basis of the store information stored in the storage unit 212 in association with the payment token and the received user ID and payment information, in response to receiving the payment token, the user ID, and the payment information from the user terminal 22 by the payment information receiving unit 2133.

In this sequence, when the user purchases the product, the code generation unit 2363 generates the payment code on the basis of the payment token stored in the storage unit 235 and displays the generated payment code on the display unit 234. However, the present invention is not limited thereto. The clerk of the store terminal 23 may print the payment code on paper or the like in advance instead of displaying the payment code on the store terminal 23 and may present the payment code printed on the paper or the like to the user when the user purchases the product.

### Modification Example 5

The payment processing device 21 displays the payment completion information and the advertisement information on the same screen of the user terminal 22, but the present invention is not limited thereto. In a case where the payment code is displayed on the store terminal 23, the payment processing device 21 may also display the advertisement information on the store terminal 23. In this case, the advertisement information transmission unit 2135 may, for example, acquire the advertisement information on the basis of the store information or the payment information acquired by the issue request acquisition unit 2131 together with the request for issuing the payment code, transmit the advertisement information together with the payment token to the store terminal 23, and display the advertisement information on the store terminal 23. The advertisement information transmission unit 2135 may include information for displaying the advertisement information in the payment token. The store terminal 23 may display the payment code including the information for displaying the advertisement information, and the user terminal 22 may display the advertisement information included in the payment code in a case where the payment code is read.

### Modification Example 6

The payment processing device 21 acquires the advertisement information at the timing when the payment request is received, but the present invention is not limited thereto. The payment processing device 21 may refer to the advertisement DB2121 at the timing when the issue request acquisition unit 2131 acquires the store information and the payment information together with the request for acquiring the payment code to acquire one or more pieces of advertisement information on the basis of the store information and the payment information. The payment processing device 21 may acquire the advertisement information to be transmitted to the user terminal 22 from the acquired advertisement information on the basis of the user ID received together with the payment request at the timing when the payment request is received.

### [Effect of Payment System 2S]

As described above, when the store information, the payment information including the amount corresponding to the payment made by the user at the store, and the request for issuing the payment code for making the payment are acquired from the store terminal 23, the payment processing device 21 stores the acquired store information and payment information and the payment token for generating the payment code in the storage unit 212 in association with each other and transmits the payment token to the store terminal 23. The payment processing device 21 receives the payment token and the user ID from the user terminal 22 that has read the payment code displayed by the store terminal 23 on the basis of the transmitted payment token. The payment processing device 21 acquires the advertisement information presented to the user on the basis of the received user ID or the store information or payment information stored in the storage unit 212 and transmits the advertisement information to the user terminal 22. By doing so, the payment processing device 21 can present the information to the user according to the purchase status of the user.

Although the present invention has been described above using the embodiment, the technical scope of the present invention is not limited to the scope described in the above embodiment, and various modifications and changes can be made within the scope of the gist. For example, specific embodiments of the distribution and integration of the device are not limited to the above embodiment, and a11 or part thereof may be functionally or physically distributed and integrated in a random unit. A new embodiment resulting from any combination of the plurality of embodiments is also included in the embodiment of the present invention. An effect of the new embodiment produced by the combination has the effect of the original embodiment together.

What is claimed is:

1. An information processing method executed by a computer, the method comprising:
acquiring a user identifier for specifying a user and a request for issuing a payment code for the user to make a payment at a store from a terminal of the user;
storing the acquired user identifier and a payment token for generating the payment code in a storage unit in association with each other;
transmitting the payment token to the terminal;
receiving the payment token, store information for identifying the store, and payment information about a purchase of a product or service by the user at the store from a store terminal that has read the payment code displayed by the terminal on a basis of the payment token;
making the payment on a basis of the user identifier associated with the payment token and the received payment information in a case where the payment token stored in the storage unit matches the received payment token;
acquiring presentation information including information about a store different from the store, information about a business operator different from a business operator operating the store, or information about a predetermined product or service on a basis of the received store information in a case where the payment token stored in the storage unit matches the received payment token; and
transmitting the acquired presentation information to the terminal.

2. The information processing method according to claim 1,
wherein the store information includes store identification information for identifying the store and business operator identification information for identifying the business operator operating the store, and
the computer acquires the presentation information associated with the business operator identification information included in the received store information, in the acquiring the presentation information.

3. An information processing method executed by a computer, the method comprising:
acquiring a user identifier for specifying a user and a request for issuing a payment code for the user to make a payment at a store from a terminal of the user;
storing the acquired user identifier and a payment token for generating the payment code in a storage unit in association with each other;
transmitting the payment token to the terminal;
receiving the payment token and payment information about a purchase of a product or service by the user at the store from a store terminal that has read the payment code displayed by the terminal on a basis of the payment token;
making the payment on a basis of the user identifier associated with the payment token and the received payment information in a case where the payment token stored in the storage unit matches the received payment token;
acquiring presentation information including information about a predetermined store, information about a predetermined business operator, or information about a predetermined product or service on a basis of the received payment information in a case where the payment token stored in the storage unit matches the received payment token; and
transmitting the acquired presentation information to the terminal.

4. The information processing method according to claim 3,
wherein the computer acquires the presentation information on a basis of a purchase amount of the product or service indicated by the payment information, in the acquiring the presentation information.

5. An information processing method executed by a computer, the method comprising:
acquiring a user identifier for specifying a user and a request for issuing a payment code for the user to make a payment at a store from a terminal of the user;
storing the acquired user identifier and a payment token for generating the payment code in a storage unit in association with each other;
transmitting the payment token to the terminal;
receiving the payment token, store information for identifying the store, and payment information about a purchase of a product or service by the user at the store from a store terminal that has read the payment code displayed by the terminal on a basis of the payment token;
making the payment on a basis of the user identifier associated with the payment token and the received payment information in a case where the payment token stored in the storage unit matches the received payment token;
acquiring presentation information including information about a predetermined store, information about a predetermined business operator, or information about a predetermined product or service on a basis of the user identifier associated with the payment token in a case where the payment token stored in the storage unit matches the received payment token; and
transmitting the acquired presentation information to the terminal.

6. The information processing method according to claim 5,
wherein the storage unit stores the number of payments made by a user corresponding to the user identifier on a basis of the payment code, a total payment amount of the payment, or store information of a store where the payment is made in association with the user identifier, and
the computer refers to the storage unit to acquire the presentation information on a basis of the number of payments, the total payment amount, or the store information which is associated with the user identifier, in the acquiring the presentation information.

7. The information processing method according to claim 5,
wherein the computer acquires the presentation information on a basis of a purchase status of the product or service purchased by the user and another user different from the user, in the acquiring the presentation information.

8. The information processing method according to claim 7,
wherein the computer refers to user information in which the user identifier is associated with attribute information indicating an attribute of a user corresponding to the user identifier to specify another user who has an attribute similar to the attribute of the user corresponding to the received user identifier, in the acquiring the presentation information.

9. The information processing method according to claim 1,
wherein the computer refers to a database in which the store information for identifying the store, product identification information for identifying a product included in the payment information, or user information as information about the user is associated with each of a plurality of pieces of the presentation information to acquire the presentation information associated with the received store information or payment information or the user information specified on a basis of the user identifier associated with the payment token, in the acquiring the presentation information.

10. The information processing method according to claim 1,
wherein the computer acquires advertisement information about a store where a code payment is possible as the presentation information, in the acquiring the presentation information.

11. The information processing method according to claim 1,
wherein the computer acquires coupon information as the presentation information, in the acquiring the presentation information.

12. The information processing method according to claim 1,
wherein the computer acquires advertisement information about another store different from a store corresponding to the received store information as the presentation information on a basis of a position of the store corresponding to the received store information, in the acquiring the presentation information.

13. The information processing method according to claim 1,
wherein the computer acquires advertisement information about a product designated in advance by the business operator operating the store where the user purchases the product or service as the presentation information, in the acquiring the presentation information.

14. The information processing method according to claim 1,
wherein the computer transmits payment completion notification information that makes a notification of completion of the payment to the terminal in association with the presentation information, in the transmitting the presentation information.
